(19) United States
(12) Patent Application Publication
(10) Pub. No.: US 2024/0429557 A1
(43) Pub. Date: Dec. 26, 2024

(54) BIPHASIC COMPONENT FOR RECHARGEABLE BATTERY AND METHOD OF MAKING THE SAME

(71) Applicant: CORNING INCORPORATED, CORNING, NY (US)

(72) Inventors: Dane Alphanso Christie, Painted Post, NY (US); Kevin Gregory Gallagher, Naperville, IL (US); Eric Emil Leonhardt, Horseheads, NY (US); Manuela Ocampo Davila, Corning, NY (US); Francielli Silva Genier, Syracuse, NY (US); Patrick David Tepesch, Corning, NY (US)

(21) Appl. No.: 18/748,358

(22) Filed: Jun. 20, 2024

Related U.S. Application Data
(60) Provisional application No. 63/522,755, filed on Jun. 23, 2023.

(51) Int. Cl. H01M 50/446; H01M 50/403; H01M 50/42; H01M 50/434

(52) U.S. Cl. CPC H01M 50/446; H01M 50/403; H01M 50/42; H01M 50/434

(57) ABSTRACT

A rechargeable battery includes: (1) a cathode current collector separated from an anode current collector by a battery distance, the anode current collector and the cathode current collector at least partially defining a battery space; (2) a cathode disposed within the battery space capable of storing alkali ions; and (3) a biphasic component disposed within the battery space between the anode current collector and the cathode, the biphasic component comprising (a) a first ceramic phase, (b) pores throughout the first ceramic phase, and (c) a second solid phase disposed within the pores of the first ceramic phase throughout (i) a separator portion of the biphasic component but not throughout (ii) an anode portion of the biphasic component, the separator portion being disposed between the anode portion and the cathode and forming a physical barrier between the pores through the first ceramic phase at the anode portion and the cathode.

### CROSS-REFERENCE TO RELATED APPLICATIONS

This application claims the benefit of priority under 35 U.S.C. § 119 of U.S. Provisional Application Ser. No. 63/522,755 filed on Jun. 23, 2023, the content of which is relied upon and incorporated herein by reference in its entirety.

### TECHNICAL FIELD

The present disclosure pertains to rechargeable batteries and methods of making the same, and more particularly to separating anodic and cathodic components thereof.

### BACKGROUND

Fossil fuels have long been a primary source of energy. However, fossil fuels are finite and, when burned to produce heat, produce a suboptimal amount of air pollution and greenhouse gases. To reduce reliance on fossil fuels as an energy source, renewable energy sources such as solar energy and wind energy are being used to generate electrical energy. The generation of electrical energy spurs demand for rechargeable batteries that can store the electrical energy that renewable energy sources (and fossil fuels too) generate in the form of chemical energy. When connected to a circuit, a chemical reaction occurs within the rechargeable battery that converts the chemical energy into electrical energy. The transformation is reversable such that subsequent electrical energy applied to the rechargeable battery reverses the chemical reaction to generate chemical energy that the rechargeable battery again stores.

There are a variety of rechargeable batteries that have been developed, each employing different materials to facilitate different chemical reactions to transform the stored chemical energy into electrical energy. Examples include nickel-cadmium (Ni—Cd), nickel-metal hydride (NiMH), lead-acid, and lithium-ion (Li-ion). Li-ion rechargeable batteries (hereinafter, Li-ion batteries) show promise over the other examples in terms of energy density, lifespan, and an absence of a so-called “memory effect.”

Li-ion batteries typically include an anode, a cathode, and an electrolyte. The first Li-ion batteries included a liquid electrolyte solution. Liquid electrolytes gave way to polymer electrolytes, which are widely used in Li-ion batteries today. Solid-state electrolytes (SSE) for Li-ion batteries are in development and potentially offer benefits in terms of lifespan and energy density over other liquid and polymer electrolytes.

The compositions of the anode and cathode for use in conjunction with SSEs for Li-ion batteries are also a subject of development. For example, some SSE Li-ion batteries incorporate a cathode and an anode made of lithium cobalt oxide and lithium titanate respectively, among other options. Some SSE Li-ion batteries incorporate an anode formed of graphite. Other SSE Li-ion batteries in development incorporate an anode that includes lithium metal. An SSE Li-ion battery with the lithium metal anode is sometimes referred to as a solid-state lithium metal battery (SSLMB). SSLMBs can potentially be made that have a higher energy density than SSE Li-ion batteries that incorporate an anode made of lithium titanate or graphite.

Several SSEs have been explored for incorporation into SSLMBs, such as lithium phosphorus oxynitride (LiPON) or lithium garnet (Li₇La₃Zr₂O₁₂ or “LLZO” for short). In such SSLMBs, the lithium metal anode and the SSE have heretofore been made to directly contact each other. However, there is a problem in that SSLMBs that include a lithium metal anode and the LLZO SSE tend to generate lithium dendrites at the anode. Dendrites are projections of lithium metal that grow from the surface of the lithium metal anode and extend into the SSE. The dendrites lead to a variety of issues that decrease performance of the SSLMB including a decrease in the critical current density (CCD) of the SSMLB.

Some SSLMBs attempt to address the dendrite formation issue by incorporating a separator between the anode and the SSE. In some instances, the separator is a relatively thin ceramic component such as LLZO (with a different morphology compared to the LLZO SSE, such as a planar morphology). However, for a variety of reasons, the current density through the LLZO separator is not uniform during charge and discharge of the SSLMB, which forms voids into and eventually through the separator. Dendrites then grow from the anode and through the separator leading to battery failure.

Other SSLMBs attempt to address the dendrite formation issue with a two-layer separator (sometimes referred to as a “bilayer”). The two-layer separator includes an ionically conductive layer in contact with the anode and an electrically insulating layer in contact with the SSE. The ionically conductive layer is more porous than the electrically insulating layer. To form the two-layer separator, precursor materials for the two layers are sintered simultaneously. The simultaneous sintering of two layers with differing compositions results in a misshaped separator without requisite flatness. The suboptimal flatness can cause suboptimal performance of the SSLMB.

Thus, there is a need for a way to address dendrite formation with SSLMBs that avoids the shortcomings of thin LLZO and two-layer separators.

### SUMMARY

The present disclosure addresses dendrite formation while avoiding those shortcomings with a biphasic component incorporated into the rechargeable battery. The biphasic component includes a first ceramic phase with pores and a second solid phase that is disposed within the pores of the first ceramic phase throughout a separator portion. A portion of the pores of the first ceramic phase in which the second solid phase is not disposed forms an anode portion of the rechargeable battery. The separator portion that the first ceramic phase and the second solid phase combine to form acts as the separator that separates the anode portion from the cathode of the battery. The first ceramic phase provides a continuous ion conduction path and thus avoids the interfacing problems that the aforementioned separator formed of a thin layer of ceramic causes. Further, the biphasic component is not layered in the sense of discrete bi-layers and thus there is no co-sintering step that would result in a flatness deviation.

According to a first aspect of the present disclosure, a rechargeable battery comprises: (1) an anode current collector; (2) a cathode current collector separated from the anode current collector by a battery distance, the anode current collector and the cathode current collector at least partially defining a battery space; (3) a cathode disposed within the battery space in electrical communication with the cathode current collector, the cathode capable of storing alkali ions; and (4) a biphasic component disposed within the battery space between the anode current collector and the cathode, the biphasic component comprising (a) a first ceramic phase, (b) pores throughout the first ceramic phase, and (c) a second solid phase disposed within the pores of the first ceramic phase throughout (i) a separator portion of the biphasic component but not throughout (ii) an anode portion of the biphasic component, the separator portion being disposed between the anode portion and the cathode and forming a physical barrier between the pores through the first ceramic phase at the anode portion and the cathode, wherein (a) the first ceramic phase provides a continuous conduction path for the alkali ions through the separator portion to the anode portion; (b) the biphasic component at the separator portion exhibits (i) an electronic conductivity of less than 10⁻⁶ S/cm and (ii) an ionic conductivity of greater than 10⁻⁵ S/cm; and (c) during a charging process of the rechargeable battery, alkali ions from the cathode are reduced to atoms of alkali metal that collect as alkali metal within the pores of the first ceramic phase at the anode portion of the biphasic component.

According to a second aspect of the present disclosure, the rechargeable battery of the first aspect further comprises: a liquid electrolyte disposed within pores of the cathode, wherein (i) the second solid phase is substantially impermeable to the liquid electrolyte, and (ii) the liquid electrolyte is conductive of the alkali ions.

According to a third aspect of the present disclosure, the rechargeable battery of the second aspect is presented, wherein the liquid electrolyte comprises an alkali metal salt dissociated within a solvent.

According to a fourth aspect of the present disclosure, the rechargeable battery of any one of the first through third aspects is presented, wherein (i) the second solid phase is not disposed throughout a cathode portion of the biphasic component, and (ii) the cathode portion is disposed between the second solid phase and the cathode.

According to a fifth aspect of the present disclosure, the rechargeable battery of the fourth aspect is presented, wherein the cathode portion of the biphasic component comprises a length parallel to the battery distance that is within a range of from greater than 0 μm to 5 μm.

According to a sixth aspect of the present disclosure, the rechargeable battery of any one of the first through fifth aspects is presented, wherein the first ceramic phase has been sintered.

According to a seventh aspect of the present disclosure, the rechargeable battery of any one of the first through sixth aspects is presented, wherein the first ceramic phase comprises a lithium garnet ceramic.

According to an eighth aspect of the present disclosure, the rechargeable battery of any one of the first through seventh aspects is presented, wherein the first ceramic phase comprises lithium lanthanum zirconium oxide (LLZO) or LLZO doped with a dopant.

According to a ninth aspect of the present disclosure, the rechargeable battery of the eighth aspect is presented, wherein the dopant comprises one or more of Al, Nb, Ta, Ga, Be, Nd, Gd, Y, Ca, Sr, W, Hf, Ti, Si, In, Bi, Sb, Mg, Sc, Dy, Yb, Ce, and Fe.

According to a tenth aspect of the present disclosure, the rechargeable battery of any one of the first through eighth aspects is presented, wherein the first ceramic phase comprises one or more of Li_{6.25}Al_{0.25}La₃Zr₂O₁₂, Li_{6.75}La₃Zr_{1.75}Nb_{0.25}O₁₂, Li_{6.5}La₃Zr_{1.5}Ta_{0.5}O₁₂, and Li_{6.75}La₃Zr_{1.75}Ta_{0.25}O₁₂.

According to an eleventh aspect of the present disclosure, the rechargeable battery of any one of the first through eighth aspects is presented, wherein the first ceramic phase comprises one or more of the following substitutions: (i) Li₇₋₃ₐLa₃Zr₂MₐO₁₂, where M=Al, Ga, or Be, and 0<a<0.33; (ii) Li₇La_{3-b}Zr₂M_{b}O₁₂, where M=Nd, Gd, or Y, and 0<b<1; (iii) Li_{7-c}La₃Zr_{2-c}M_{c}O₁₂, with M=Nb or Ta, and 0<c<1; (iv) Li_{7+d}La_{3-d}Zr₂M_{d}O₁₂, where M=Ca or Sr, and 0<d<1; (v) Li_{7+2c}La₃Zr₂₋ₑMₑO₁₂, where M=Ca and 0<e<0.25; and (vi) Li_{7-2f}La₃Zr_{2-f}M_{f}O₁₂, where M=W and 0<f<0.5.

According to a twelfth aspect of the present disclosure, the rechargeable battery of any one of the first through eleventh aspects is presented, wherein the second solid phase comprises a polymer.

According to a thirteenth aspect of the present disclosure, the rechargeable battery of the twelfth aspect is presented, wherein the polymer comprises a thermoplastic polymer.

According to a fourteenth aspect of the present disclosure, the rechargeable battery of the thirteenth aspect is presented, wherein the thermoplastic polymer comprises one or more of polypropylene, polyethylene, or polystyrene.

According to a fifteenth aspect of the present disclosure, the rechargeable battery of the twelfth aspect is presented, wherein the polymer comprises a thermoset polymer.

According to a sixteenth aspect of the present disclosure, the rechargeable battery of the fifteenth aspect is presented, wherein the thermoset polymer comprises vulcanized rubber.

According to a seventeenth aspect of the present disclosure, the rechargeable battery of the fifteenth aspect is presented, wherein the thermoset polymer comprises a thermoset resin.

According to an eighteenth aspect of the present disclosure, the rechargeable battery of the seventeenth aspect is presented, wherein the thermoset resin comprises one or more of an epoxy resin, an amine-epoxide resin, a phenolic resin, an isocyanate resin, a phenolic resin, a polyimide resin, a silicone resin, a (meth)acrylate resin, a polyurethane resin, and a polyurea resin.

According to a nineteenth aspect of the present disclosure, the rechargeable battery of the eighteenth aspect is presented, wherein the (meth)acrylate resin comprises one or more of a urethane-(meth)acrylate and an epoxy-(meth)acrylate, with one or more reactive diluents.

According to a twentieth aspect of the present disclosure, the rechargeable battery of the twelfth aspect is presented, wherein the polymer is derived from polymerization of one or more of poly(ethylene glycol) methacrylate, polyethylene glycol diacrylate, methacrylated polytetrahydrofuran, poly(ethylene glycol) dimethyl ether acrylate, poly(ethylene glycol) methyl ether acrylate, and trimethylolpropane propoxylate triacrylate.

According to a twenty-first aspect of the present disclosure, the rechargeable battery of any one of the twelfth through twentieth aspects is presented, wherein the polymer exhibits an ionic conductivity within a range of from 10⁻⁷ S/cm to 10⁻⁴ S/cm.

According to a twenty-second aspect of the present disclosure, the rechargeable battery of any one of the first through twenty-first aspects is presented, wherein the second solid phase exhibits an ionic conductivity that is greater than 10⁻⁷ S/cm.

According to a twenty-third aspect of the present disclosure, the rechargeable battery of any one of the first through twenty-second aspects is presented, wherein the second solid phase comprises an alkali metal salt.

According to a twenty-fourth aspect of the present disclosure, the rechargeable battery of the twenty-third aspect is presented, wherein the alkali metal salt comprises one or more of lithium bis(trifluoromethanesulfonyl)imide and lithium bis(fluorosulfonyl)imide.

According to a twenty-fifth aspect of the present disclosure, the rechargeable battery of the twenty-third aspect is presented, wherein the alkali metal salt comprises one or more salts of the formula J₃MX₆, where J is an alkali metal, M is a trivalent rare earth metal, and X is F, Cl, Br, or I.

According to a twenty-sixth aspect of the present disclosure, the rechargeable battery of any one of the first through twenty-fifth aspects is presented, wherein the second solid phase exhibits a Young's modulus of greater than or equal to 0.5 MPa at 25° C.

According to a twenty-seventh aspect of the present disclosure, the rechargeable battery of any one of the first through twenty-sixth aspects is presented, wherein the second solid phase exhibits a Young's modulus of greater than or equal to 1 GPa at 25° C.

According to a twenty-eighth aspect of the present disclosure, the rechargeable battery of any one of the first through twenty-seventh aspects is presented, wherein (i) the alkali metal is lithium; and (ii) the alkali ions are lithium ions.

According to a twenty-ninth aspect of the present disclosure, the rechargeable battery of any one of the first through twenty-seventh aspects is presented, wherein (i) the alkali metal is sodium; and (ii) the alkali ions are sodium ions.

According to a thirtieth aspect of the present disclosure, the rechargeable battery of any one of the first through twenty-ninth aspects is presented, wherein the anode portion of the biphasic component comprises a length parallel to the battery distance that is within a range of from 5 μm to 150 μm.

According to a thirty-first aspect of the present disclosure, the rechargeable battery of any one of the first through thirtieth aspects is presented, wherein the separator portion of the biphasic component comprises a length parallel to the battery distance that is within a range of from 1 μm to 50 μm.

According to a thirty-second aspect of the present disclosure, a method of manufacturing a rechargeable battery comprises: (a) with a ceramic comprising (i) pores throughout the ceramic, (ii) a first primary surface, (iii) a second primary surface, and (iv) a length between the first primary surface and the second primary surface, a contacting step comprising contacting the first primary surface of the ceramic with a flowable component so that the flowable component enters the pores of the ceramic and resides within the pores through less than an entirety of the length of the ceramic; (b) a solidifying step comprising solidifying the flowable component residing within the pores of the ceramic, thus resulting in a biphasic component comprising (i) a first primary surface contiguous with the first primary surface of the ceramic, the ceramic representing a first ceramic phase, (ii) pores throughout the first ceramic phase, and (iii) a second solid phase derived from solidifying the flowable component disposed within the pores; and (c) a disposing step comprising disposing the biphasic component between an anode current collector and a cathode, with the first primary surface of the biphasic component disposed facing the cathode.

According to a thirty-third aspect of the present disclosure, the thirty-second aspect is presented, wherein the ceramic is a lithium garnet ceramic.

According to a thirty-fourth aspect of the present disclosure, any one of the thirty-second through thirty-third aspects is presented, wherein the contacting step comprises (i) casting the flowable component onto a liner at least partially transparent to ultraviolet radiation and (ii) placing the first primary surface of the ceramic into the flowable component that was casted.

According to a thirty-fifth aspect of the present disclosure, any one of the thirty-second through thirty-fourth aspects is presented, wherein the contacting step comprises coating the flowable component onto the first primary surface of the ceramic.

According to a thirty-sixth aspect of the present disclosure, any one of the thirty-second through thirty-fifth aspects is presented, wherein the solidifying step comprises exposing the flowable component to a wavelength or wavelength range of electromagnetic radiation that cures the flowable component.

According to a thirty-seventh aspect of the present disclosure, any one of the thirty-second through thirty-sixth aspects is presented, wherein the solidifying step comprises subjecting the flowable component to a temperature that cures the flowable component.

According to a thirty-eighth aspect of the present disclosure, any one of the thirty-second through thirty-seventh aspects is presented, wherein the flowable component comprises a thermosetting resin.

According to a thirty-ninth aspect of the present disclosure, the thirty-eighth aspect is presented, wherein the thermoset resin comprises one or more of an epoxy resin, an amine-epoxide resin, a phenolic resin, an isocyanate resin, a phenolic resin, a polyimide resin, a silicone resin, a (meth)acrylate resin, a polyurethane resin, and a polyurea resin.

According to a fortieth aspect of the present disclosure, the thirty-ninth aspect is presented, wherein the (meth)acrylate resin comprises one or more of a urethane-(meth)acrylate and an epoxy-(meth)acrylate, with one or more reactive diluents.

According to a forty-first aspect of the present disclosure, any one of the thirty-second through the fortieth aspects is presented, wherein the flowable component comprises neat monomers.

According to a forty-second aspect of the present disclosure, any one of the thirty-second through the forty-first aspects is presented, wherein the flowable component comprises (i) a difunctional acrylate monomer and (ii) a trifunctional acrylate monomer.

According to a forty-third aspect of the present disclosure, any one of the thirty-second through the forty-second aspects is presented, wherein the flowable component comprises a curing agent.

According to a forty-fourth aspect of the present disclosure, any one of the thirty-second through the forty-third aspects is presented, wherein (i) the flowable component is a solid at room temperature but a liquid at an elevated temperature; (ii) the contacting step occurs while the flowable component is the liquid at the elevated temperature; and (iii) the solidifying step comprises returning the flowable component to room temperature.

According to a forty-fifth aspect of the present disclosure, any one of the thirty-second through forty-fourth aspects is presented, wherein the flowable component comprises a thermoplastic polymer.

According to a forty-sixth aspect of the present disclosure, any one of the thirty-second through the forty-fifth aspects is presented, wherein the flowable component is substantially free of a solvent.

According to a forty-seventh aspect of the present disclosure, any one of the thirty-second through the forty-sixth aspects is presented, wherein the flowable component comprises an alkali metal salt.

According to a forty-eighth aspect of the present disclosure, any one of the thirty-second through the forty-seventh aspects further comprises a removal step comprising removing a portion of the second solid phase at the first primary surface of the biphasic component.

### BRIEF DESCRIPTION OF THE DRAWINGS

In the Drawings:

FIG. 1 is a schematic cross-sectional diagram of a rechargeable battery of the present disclosure, illustrating the rechargeable battery including a biphasic component disposed between an anode current collector and a cathode of the rechargeable battery;

FIG. 2 is a schematic cross-sectional diagram of the biphasic component, illustrating a first ceramic phase with pores disposed throughout and a second solid phase disposed within the pores at a separator portion but not at an anode portion or a cathode portion of the biphasic component;

FIG. 3 is a flow chart of a method of making the biphasic component and the rechargeable battery, illustrating a contacting step, a solidifying step, a removal step, and a disposing step;

FIG. 4 is a schematic diagram of a ceramic with pores about to be lowered into a flowable component to achieve the contacting step of the method of FIG. 3;

FIG. 5 is a schematic diagram of the contacting step of the method of FIG. 3, illustrating the flowable component infiltrating the pores of the ceramic;

FIG. 6 is a schematic diagram of the solidifying step of the method of FIG. 3, illustrating the flowable component within the pores of the ceramic before the flowable component becomes the second solid phase of the biphasic component as a result of the solidifying step;

FIG. 7 is a schematic diagram of the removal step of the method of FIG. 3, illustrating the biphasic component contacting an etchant to etch selectively (or more selectively) the second solid phase than the first ceramic phase to reveal the cathode portion of the biphasic component; and

FIG. 8, pertaining to Example 1, reproduces scanning electron microscopy (SEM) images of a cross-section of a biphasic component, illustrating the second solid phase disposed within pores of the first ceramic phase.

### DETAILED DESCRIPTION

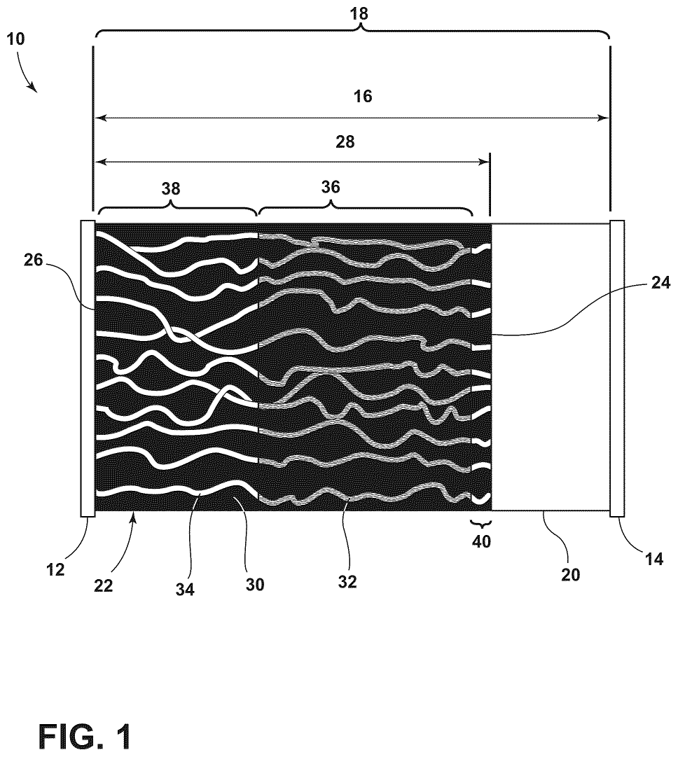

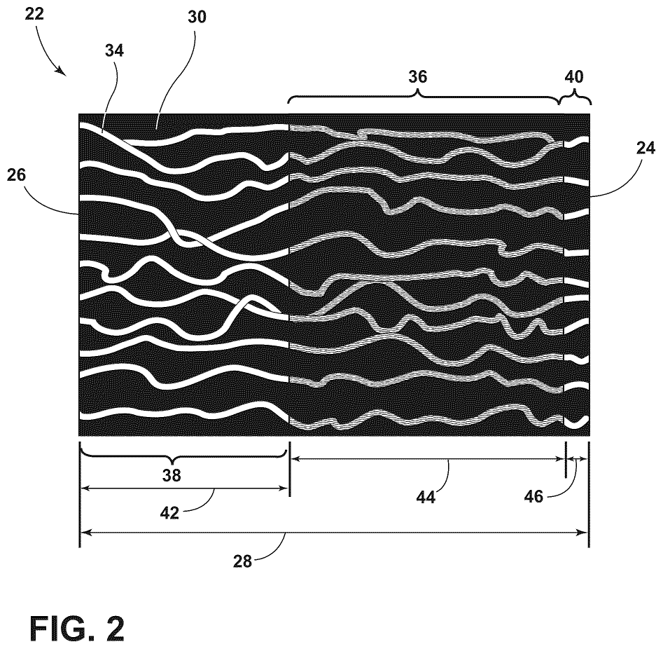

In reference to FIGS. 1 and 2, a rechargeable battery 10 includes an anode current collector 12 and a cathode current collector 14. The anode current collector 12 and the cathode current collector 14 are separated by a battery distance 16. The anode current collector 12 and the cathode current collector 14 at least partially define a battery space 18. The anode current collector 12 and the cathode current collector 14 act as conductive interfaces between the rechargeable battery 10 and an external circuit (not illustrated) and facilitate the flow of electrical current therebetween. In embodiments, the anode current collector 12 and the cathode current collector 14 are made of an electrically conductive material such as copper or aluminum. The rechargeable battery 10 can participate in both a discharging process and a charging process. In the discharging process, chemical energy stored within the rechargeable battery 10 is converted to electrical energy, which is communicated to the external circuit. In the charging process, electrical energy from the external circuit is communicated to the rechargeable battery 10, which converts the electrical energy to chemical energy.

The rechargeable battery 10 further includes a cathode 20. The cathode 20 is disposed between the anode current collector 12 and the cathode current collector 14 within the battery space 18. The cathode 20 is disposed closer to the cathode current collector 14 than the anode current collector 12. The cathode 20 is in electrical communication with the cathode current collector 14. In embodiments, the cathode 20 directly contacts the cathode current collector 14.

The cathode 20 can be made of any material that is able to receive and store alkali ions during the discharging process and discharge the alkali ions during the charging process. In embodiments, the cathode 20 includes an alkali metal oxide, such as lithium cobalt oxide (LiCoO₂), lithium nickel manganese cobalt oxide (Li-NMC), or lithium iron phosphate (LiFePO₄). Such materials have a crystal structure, such as an olivine structure in the case of lithium iron phosphate (LiFePO₄). Alkali ions can move into (intercalate) and out of (deintercalate) the empty sites within the crystal structure of the cathode 20 during the discharging process and the charging process, respectively.

In embodiments, the cathode 20 is porous. In embodiments, the rechargeable battery 10 further includes a liquid electrolyte disposed within the pores of the cathode 20. The liquid electrolyte can improve the performance of the cathode 20 by, among other things, providing a larger surface area for electrochemical reactions to occur. In embodiments, the liquid electrolyte is conductive of the alkali ions.

In embodiments, the liquid electrolyte includes an alkali metal salt dissociated within solvent. The solvent can be an organic solvent. Suitable organic solvents include ethylene carbonate/dimethyl carbonate mixtures and propylene carbonate/ethyl methyl carbonate mixtures. Other organic solvents are envisioned. The alkali metal salt can include one or more of lithium perchlorate (LiClO₄), lithium tetrafluoroborate (LiBF₄), lithium hexafluoroarsenate (LiAsF₆), lithium hexafluorophosphate (LiPF₆), lithium bis(oxalato) borate (LiBOB), lithium difluorooxalate borate (LiDFOB), lithium bisdifluorosulfonimide (LiFSI), lithium bistrifluoromethanesulfonimide (LiTFSI), lithium bis(trifluoromethanesulfonyl)imide (LiTFSI), lithium hexafluorophosphate (LiPF₆), lithium hexafluoroarsenate (LiAsF₆), lithium perchlorate (LiClO₄), lithium trifluoromethanesulfonate (LiOTf), lithium bis(oxalate)borate (LiBOB), lithium difluoro(oxalate)borate (LiDFOB), lithium tetrafluoroborate (LiBF₄), lithium bis(fluorosulfonyl)imide (LiFSI), lithium bis(pentafluoroethanesulfonyl)imide (LiBETI), lithium bis(oxalato)borate tetrafluoroborate (LiBOB LiBF₄), and lithium difluorophosphate (LiDFP). Other alkali metal salts are envisioned, and these lists are not meant to be exclusive.

The rechargeable battery 10 further includes a biphasic component 22. The biphasic component 22 is disposed within the battery space 18. The biphasic component 22 is disposed between the anode current collector 12 and the cathode 20. The biphasic component 22 includes a first primary surface 24 and a second primary surface 26, which faces in a generally opposite direction as the first primary surface 24. The first primary surface 24 of the biphasic component 22 faces the cathode 20. The second primary surface 26 of the biphasic component 22 faces the anode current collector 12. The biphasic component 22 has a length 28 that extends between the first primary surface 24 and the second primary surface 26. The length of the biphasic component 22 is less than the battery distance 16.

“Biphasic component” means that the component has at least two phases of material. In particular, the biphasic component 22 includes a first ceramic phase 30 and a second solid phase 32. The second solid phase 32 is different than the first ceramic phase 30. The first ceramic phase 30 is porous. That is, the biphasic component 22 further includes pores 34 disposed throughout the first ceramic phase 30. The second solid phase 32 is disposed within the pores 34 of the first ceramic phase 30 but not throughout an entirety of the length 28 of the biphasic component 22. Rather, the second solid phase 32 is disposed throughout a separator portion 36 of the biphasic component 22 (and thus the rechargeable battery 10) but not throughout an anode portion 38 of the biphasic component 22 (and thus the rechargeable battery 10). In other words, the second solid phase 32 occupies the pores 34 of the first ceramic phase 30 only throughout a part of the length 28 of the biphasic component 22. The part of the length 28 of the biphasic component 22 where the pores 34 of the first ceramic phase 30 are occupied by the second solid phase 32 represents the separator portion 36. The pores 34 of the first ceramic phase 30 at the anode portion 38 of the biphasic component 22 can be open (depending on the state of charge/discharge of the rechargeable battery 10) and the second solid phase 32 does not occupy the pores 34 at the anode portion 38. The anode portion 38 is disposed closer to the anode current collector 12 than the second solid phase 32. The separator portion 36, where the second solid phase 32 occupies the pores 34 of the first ceramic phase 30, is disposed between the anode portion 38 and the cathode 20. The separator portion 36 forms a physical barrier between the pores 34 through the first ceramic phase 30 that are open at the anode portion 38 and the cathode 20.

In embodiments, the second solid phase 32 is not disposed throughout a cathode portion 40 of the biphasic component 22 (and thus the rechargeable battery 10). In other words, at the cathode portion 40, like at the anode portion 38, the pores 34 throughout the first ceramic phase 30 of the biphasic component 22 are open and not occupied by the second solid phase 32. In such embodiments, the separator portion 36 is disposed between the anode portion 38 and the cathode portion 40. The separator portion 36 forms a physical barrier between the open pores 34 at the anode portion 38 and the open pores 34 at the cathode portion 40. In such embodiments, the pores 34 throughout the first ceramic phase 30 are open at both the first primary surface 24 and the second primary surface 26 of the biphasic component 22. The cathode portion 40 is disposed between the second solid phase 32 and the cathode 20. The cathode portion 40 is disposed between the separator portion 36 and the cathode 20. The open pores 34 of the first ceramic phase 30 at the cathode portion 40 increases the surface area for the transfer of alkali ions between the first ceramic phase 30 and the liquid electrolyte in the pores 34 of the cathode 20. The liquid electrolyte can enter the pores 34 of the first ceramic phase 30 at the cathode portion 40 but is physically blocked by the second solid phase 32 at the separator portion 36 from progressing further toward the anode portion 38.

The first ceramic phase 30 provides a continuous conduction path for the alkali ions through the separator portion 36 to the anode portion 38. For example, during the charging process of the rechargeable battery 10, alkali ions leave the cathode 20, enter the first ceramic phase 30 of the biphasic component 22, and conduct along the first ceramic phase 30 past the separator portion 36 and into the anode portion 38. Without being bound by theory, the first ceramic phase 30 conducts alkali ions via ionic diffusion, where defects in the crystal structure of the first ceramic phase 30 create mobile sites through which the alkali ions can travel. Such defects include atom vacancies and out of place atomic species, among other possibilities.

In embodiments, the first ceramic phase 30 has been sintered. Sintering generally increases the density and mechanical strength of the first ceramic phase 30. In addition, sintering reduces the number of grain boundaries that would otherwise limit alkali ion conductivity through the first ceramic phase 30.

In embodiments, the first ceramic phase 30 includes a lithium garnet ceramic. Lithium garnet ceramics have a relatively high alkali ion conductivity. An example lithium garnet ceramic is lithium lanthanum zirconium oxide (LLZO). Without being bound by theory, LLZO conducts alkali ions well, because of the presence of a relatively high number of atomic vacancies in the crystal structure.

In embodiments, the first ceramic phase 30 includes LLZO doped with a dopant. Without being bound by theory, the dopant can increase the ionic conductivity of the LLZO and thus the first ceramic phase 30. Such dopants can include one or more of Al, Nb, Ta, Ga, Be, Nd, Gd, Y, Ca, Sr, W, Hf, Ti, Si, In, Bi, Sb, Mg, Sc, Dy, Yb, Ce, and Fe. Note that more than one dopant can be utilized (e.g., LLZO doped with both Ta and Nb). As more specific examples, the first ceramic phase 30 can include one or more of Li_{6.25}Al_{0.25}La₃Zr₂O₁₂, Li_{6.75}La₃Zr_{1.75}Nb_{0.25}O₁₂, Li_{6.5}La₃Zr_{1.5}Ta_{0.5}O₁₂, and Li_{6.75}La₃Zr_{1.75}Ta_{0.25}O₁₂. In embodiments, the first ceramic phase 30 includes one or more of the following substitutions: (i) Li₇₋₃ₐLa₃Zr₂MₐO₁₂, where M=Al, Ga, or Be, and 0<a<0.33; (ii) Li₇La_{3-b}Zr₂M_{b}O₁₂, where M=Nd, Gd, or Y, and 0<b<1; (iii) Li_{7-c}La₃Zr_{2-c}MₑO₁₂, with M=Nb or Ta, and 0<c<1; (iv) Li_{7+d}La_{3-d}Zr₂M_{d}O₁₂, where M=Ca or Sr, and 0<d<1; (v) Li₇₊₂ₑLa₃Zr₂₋ₑMₑO₁₂, where M=Ca and 0<e<0.25; and (vi) Li_{7-2f}La₃Zr_{2-f}M_{f}O₁₂, where M=W and 0<f<0.5.

The biphasic component 22 at the separator portion 36 exhibits (i) an electronic conductivity of less than 10⁻⁶ S/cm and (ii) an ionic conductivity of greater than 10⁻⁵ S/cm. Although the first ceramic phase 30 does not conduct electricity well but does conduct alkali ions well, the second solid phase 32 ought to be selected not to impart electronic conductivity to the biphasic component 22 at the separator portion 36 thereof. In addition, the second solid phase 32 ought to be selected not to hinder ionic conductivity through the biphasic component 22 at the separator portion 36 thereof. Further, in embodiments, the second solid phase 32 resists or at least substantially resists reduction by the alkali metal disposed within the anode portion 38. Moreover, in embodiments, the second solid phase 32 is substantially impermeable to the liquid electrolyte, if included within the pores 34 of the cathode 20.

In embodiments, the second solid phase 32 is or includes a polymer. For example, the polymer can be a thermoplastic polymer or a thermoset polymer. Suitable thermoplastic polymers include polypropylene, polyethylene, or polystyrene. In some instances, other thermoplastic polymers may be suitable such as polyvinyl chloride (PVC), polyurethane (PU), polyamide (PA), polycarbonate (PC), and acrylonitrile-butadiene-styrene (ABS). Suitable thermoset polymers include vulcanized rubber and thermoset resins, such as an epoxy resin, an amine-epoxide resin, a phenolic resin, an isocyanate resin, a phenolic resin, a polyimide resin, a silicone resin, a (meth)acrylate resin, a polyurethane resin, and a polyurea resin. Suitable (meth)acrylate resins include a urethane-(meth)acrylate resin and an epoxy-(meth)acrylate resin, among others, and one or more reactive diluents. In embodiments, the second solid phase 32 is free of succinonitrile.

In embodiments, the polymer is derived from polymerized (meth)acrylate monomers. Suitable (meth)acrylate monomers include poly(ethylene glycol) methacrylate, polyethylene glycol diacrylate, methacrylated polytetrahydrofuran, poly(ethylene glycol) dimethyl ether acrylate, poly(ethylene glycol) methyl ether acrylate, and trimethylolpropane propoxylate triacrylate. Whether the resulting polymer is thermoplastic or thermoset depends on whether the monomers are cross-linked during polymerization. In embodiments, the polymer is a thermoset polymer derived from polymerization and cross-linking of polymerized (meth)acrylate monomers, such as those listed. These lists are not meant to be exclusive.

In embodiments, the second solid phase 32 does not conduct alkali ions or electrons, such as when the second solid phase 32 comprises polypropylene or polyethylene. However, having the second solid phase 32 exhibit a degree of ionic conductivity helps facilitate adequate ionic conductivity through the separator portion 36 of the biphasic component 22. In embodiments, the second solid phase 32 exhibits an ionic conductivity that is greater than 10⁻⁷ S/cm.

In embodiments, the polymer (if included) of the second solid phase 32 itself exhibits an ionic conductivity that is greater than 10⁻⁷ S/cm, such as within a range of from 10⁻⁷ S/cm to 10⁻⁴ S/cm. For example, an alkali-ion conducting polymer can be obtained via linking anions of an alkali ion salt to a polymeric backbone covalently. The synthesis could be either (i) chemical modification of existing polymers or (ii) direct polymerization of lithium salt monomers. In the first case, the polymer is constructed by incorporating the anionic group of an alkali metal salt into the polymer backbone. In the second case, a lithium metal salt with a functionalized anion can be incorporated to a polymerizable unit (e.g., a styrene-containing group), which can be incorporated to have a flexible, oligomeric ethylene unit as a spacer arm to facilitate flexibility of the polymer backbone.

In embodiments, the second solid phase 32 can include an alkali metal salt. The presence of the alkali metal salt within the second solid phase 32, such as added to a polymer, can increase the ionic conductivity of the second solid phase 32. Suitable alkali metal salts include the lithium metal salts mentioned above, especially lithium bis(trifluoromethanesulfonyl)imide and lithium bis(fluorosulfonyl)imide. For example, the second solid phase 32 can include lithium salt within a thermoset polymer that includes polar functional groups such as —O—, C═O, —O—C═O, —N—, or C—N. In such instances, the polymer forms polymer-Li⁺ complexes. Examples of such polymers include polymers polymerized from poly(ethylene glycol) methacrylate, polyethylene glycol diacrylate, methacrylated polytetrahydrofuran, poly(ethylene glycol) dimethyl ether, poly(ethylene glycol) methyl ether acrylate, and trimethylolpropane propoxylate triacrylate.

In other embodiments, the alkali metal salts in the second solid phase 32 are of the formula J₃MX₆, where J is an alkali metal, M is a trivalent rare earth metal, and X is F, Cl, Br, or I. With such salts, an alkali metal cation (J⁺) and a trivalent rare earth metal cation (M³⁺) are ionically bonded to six halide anions (X⁻) in 3:1 ratio. Examples include Li₃YCl₆, Li₃ScCl₆, Li₃GdCl₆, Li₃LuCl₆, Li₃LaBr₆, Na₃YCl₆, K₃YCl₆, Cs₃YCl₆, Na₃ScCl₆, and K₃ScCl₆. Other alkali metal salts, including other salts of formula J₃MX₆, are envisioned. These lists are not meant to be exclusive.

A second solid phase 32 can exhibit a wide range of material properties. For example, in embodiments, the second solid phase 32 exhibits a Young's modulus of greater than or equal to 0.5 MPa at 25° C. In embodiments, the second solid phase 32 exhibits a Young's modulus of greater than or equal to 1 GPa at 25° C. Certain of the mechanical properties including Young's modulus of the second solid phase 32 can be determined using an Instron 2G load cell frame. The material of the second solid phase 32 is injected into 0.0024 inch ID tubing and cured, such as with UV radiation to produce rods of the material of the second solid phase 32. The rods are cut into samples 5 inches in length for testing with the Instron 2G load cell frame. The Instron 2G load cell frame then pulls each rod to failure and the instrument software calculates the mechanical properties, including the Young's modulus.

In embodiments, the alkali metal and the alkali ions that are utilized and present within the rechargeable battery 10 are lithium and lithium ions, respectively. In other embodiments, the alkali metal is sodium and the alkali ions are sodium ions. Other alkali metals and other alkali ions are envisioned. The alkali metal can be a combination of alkali metals such as a combination of lithium and sodium. The alkali ions can be a combination of alkali ions such as a combination of lithium ions and sodium ions.

In embodiments, the anode portion 38 of the biphasic component 22 (and thus the rechargeable battery 10) has a length 42 parallel to the battery distance 16 and the length 28 of the biphasic component 22 that is within a range of from 5 μm to 150 μm. In embodiments, the length 42 of the anode portion 38 is 5 μm, 10 μm, 20 μm, 30 μm, 40 μm, 50 μm, 60 μm, 70 μm, 80 μm, 90 μm, 100 μm, 110 μm, 120 μm, 130 μm, 140 μm, or 150 μm, or within any range bound by any two of those values (e.g., from 10 μm to 120 μm, from 40 μm to 90 μm, and so on).

In embodiments, the separator portion 36 of the biphasic component 22 (and thus the rechargeable battery 10) has a length 44 parallel to the battery distance 16 and the length 28 of the biphasic component 22 that is within a range of from 1 μm to 50 μm. In embodiments, the length 44 of the separator portion 36 is 1 μm, 5 μm, 10 μm, 15 μm, 20 μm, 25 μm, 30 μm, 40 μm, 45 μm, or 50 μm, or within any range bound by any two of those values (e.g., from 1 μm to 10 μm, from 5 μm to 20 μm, and so on).

In embodiments, the cathode portion 40 of the biphasic component 22 (and thus the rechargeable battery 10) has a length 46 parallel to the battery distance 16 and the length 28 of the biphasic component 22 that is within a range of from greater than 0 μm to 5 μm. In embodiments, the length 46 of the cathode portion 40 is greater than 0 μm, 1 μm, 2 μm, 3 μm, 4 μm, or 5 μm (or within any range bound by any two of those values).

In use, the rechargeable battery 10 can be subjected to a charging process and a discharging process. In the charging process, a voltage from an external circuit is applied to the rechargeable battery 10. The voltage causes an electric field that makes the anode portion 38 to be more negatively charged than the cathode 20. The negative charge causes the release of alkali ions and electrons from the cathode 20. The alkali ions enter the biphasic component 22, transport within the biphasic component 22 through the separator portion 36, and then into anode portion 38. The electrons travel through the external circuit to the anode portion 38 through the anode current collector 12. At the anode portion 38, the alkali ions gain electrons from the external circuit and form alkali metal. In other words, the electrons reduce the alkali ions to atoms of alkali metal. The atoms of alkali metal collect as alkali metal within the pores 34 of the first ceramic phase 30 at the anode portion 38.

In the discharging process, the opposite occurs. The potential of the cathode 20 becomes more positive, which attracts lithium ions from the anode portion 38. Alkali ions and electrons release from the alkali metal within the anode portion 38. The electrons enter the external circuit and travel to the cathode 20. The alkali ions travel back through the biphasic component 22 to the cathode 20, passing through the separator portion 36 on the way. The alkali ions and electrons react with the cathode 20.

The biphasic component 22 addresses the problems mentioned in the Background, for a variety of reasons. First, the second solid phase 32 within the pores 34 of the first ceramic phase 30 at the separator portion 36 prevents the formation of dendrites that extend from the anode portion 38 through to the cathode 20. Unlike separators previously described that are relatively thin ceramic components with a different morphology than the separator, the first ceramic phase 30 of the biphasic component 22 is a contiguous piece with a constant morphology. The biphasic component 22 thus provides uniform current density during charge and discharge, which avoids the formation of voids through which dendrites can grow. Second, unlike separators that are made of two-distinct layers, the biphasic component 22 is two distinct phases—the second solid phase 32 disposed within the pores 34 of a larger first ceramic phase 30 that acts as a scaffolding of sorts. The incorporation of the larger first ceramic phase 30 within which the second solid phase 32 is disposed avoids the loss of flatness that arises during the simultaneous sintering of two distinct layers of different material. Third, the first ceramic phase 30 provides a larger surface area through which to pass current than the separators described in the Background. The larger surface area further allows for faster transport of alkali ions and higher current densities, which lead to higher energy densities and a smaller size for the rechargeable battery 10.

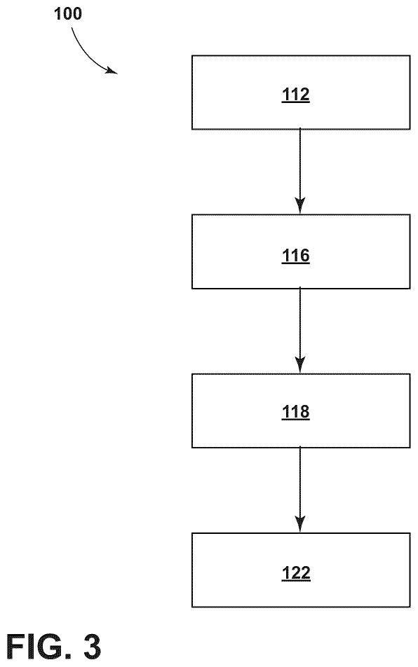

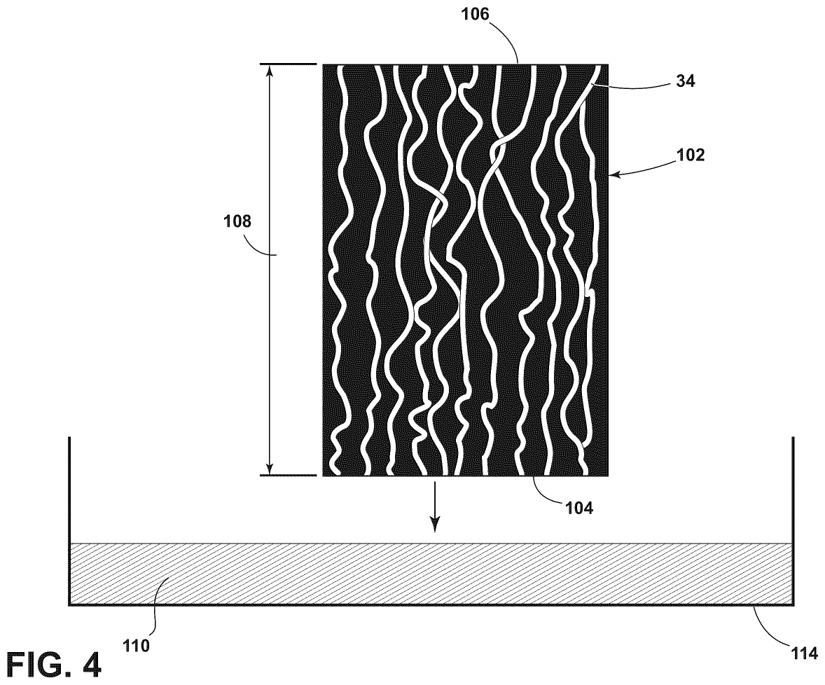

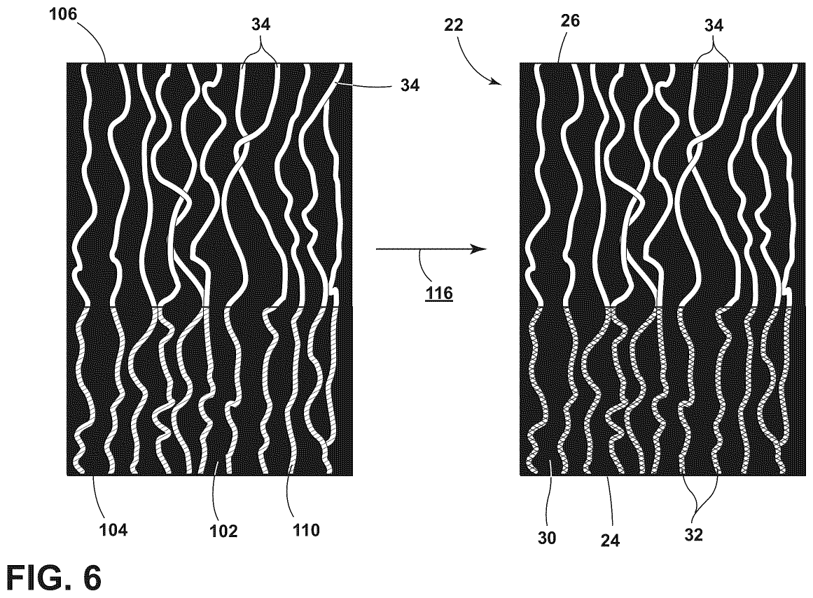

Referring now to FIGS. 3-7, further described herein is a method 100 of manufacturing the rechargeable battery 10. The method 100 utilizes a ceramic 102 (e.g., the first ceramic phase 30). The ceramic 102 includes pores 34 throughout the ceramic 102, a first primary surface 104, and a second primary surface 106. The first primary surface 104 and the second primary surface 106 face in opposite directions. The pores 34 of the ceramic 102 are open at the first primary surface 104 and the second primary surface 106. The ceramic 102 has a length 108 between the first primary surface 104 and the second primary surface 106. The ceramic 102 can be any ceramic 102 including those ceramics discussed for the first ceramic phase 30 above, such as a lithium garnet ceramic. A flowable component 110 is also utilized (see FIG. 4).

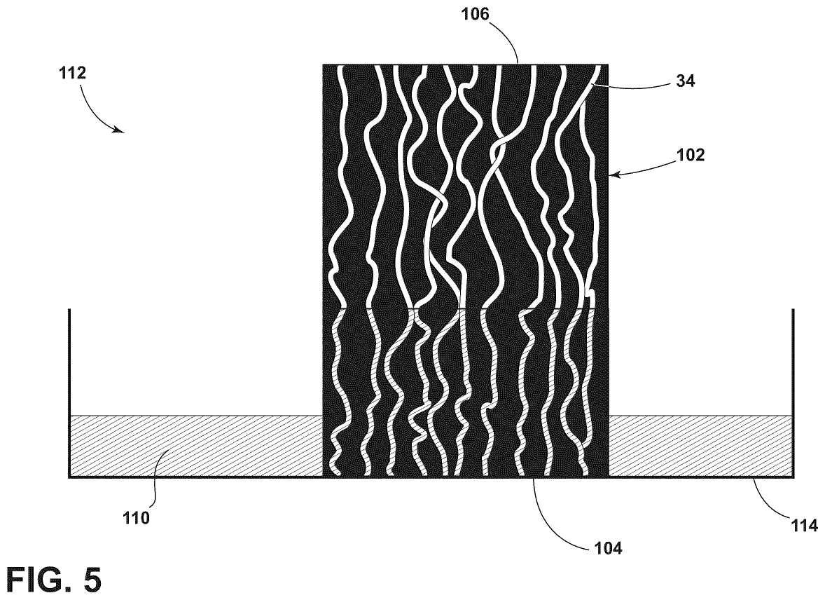

The method 100 includes a contacting step 112. The contacting step 112 includes contacting the first primary surface 104 of the ceramic 102 with the flowable component 110 so that the flowable component 110 enters the pores 34 of the ceramic 102 and resides within the pores 34 through less than the entirety of the length 108 of the ceramic 102 (see FIG. 5). In embodiments, the contacting step 112 includes (i) casting the flowable component 110 onto a liner 114 and (ii) placing the first primary surface 104 of the ceramic 102 into the flowable component 110. In embodiments, the liner 114 is at least partially transparent to a wavelength or wavelength range of electromagnetic radiation that cures the flowable component 110. Suitable examples depend on the wavelength range that facilitates curing. Some examples include polyethylene terephthalate (PET), quartz, borosilicate glass, and polymethyl methacrylate.

In embodiments, the contacting step 112 comprises coating the flowable component 110 onto the first primary surface 104 of the ceramic 102. For example, a roll coater, a blade coater, a drawdown applicator, or a brush can be utilized to coat the flowable component 110 onto the first primary surface 104 of the ceramic 102. Coating mechanisms such as drawdown bar applicators can deposit a predetermined thickness or coat weight of the flowable component 110 such that even if all the flowable component 110 enters the pores 34, the flowable component 110 will not occupy the pores 34 through the entirety of the length 108 of the ceramic 102.

The flowable component 110 should have a viscosity at a temperature at which the contacting step 112 occurs that allows the flowable component 110 to flow into the pores 34 of the ceramic 102. How far into the length 108 of the ceramic 102 the flowable component 110 enters is a function of the time the ceramic 102 contacts the flowable component 110, the thickness of the flowable component 110 on the liner 114, and the viscosity of the flowable component 110. The viscosity of the flowable component 110 that both allows the flowable component 110 to flow into the pores 34 of the ceramic 102 and does not occupy the entire length 108 of the ceramic 102 depends at least on how the contacting step 112 is conducted, such as whether the first primary surface 104 of the ceramic 102 is dipped downward into the flowable component 110 or whether the flowable component is applied via coating onto the first primary surface 104 while the first primary surface 104 is facing upwards.

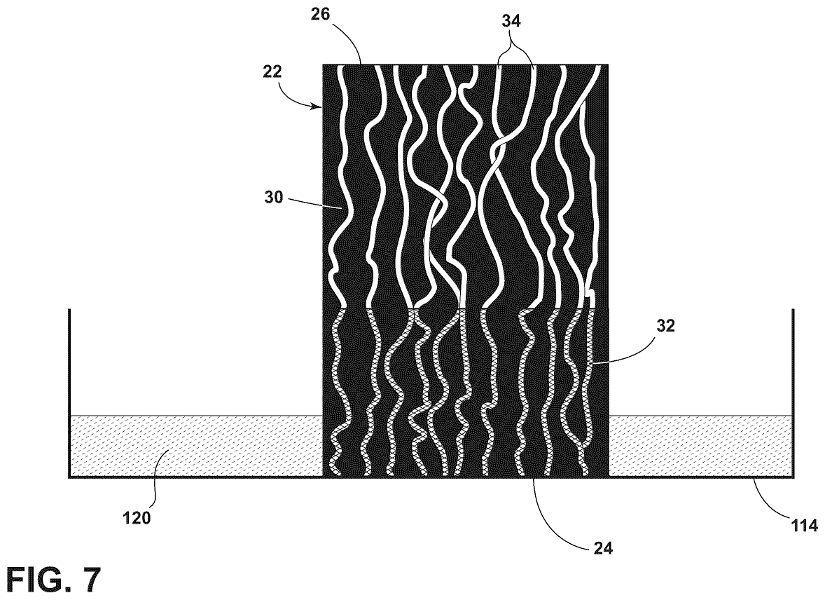

The method 100 further includes a solidifying step 116. The solidifying step 116 includes solidifying the flowable component 110 within the pores 34 of the ceramic 102 (see FIG. 7). How the flowable component 110 is solidified depends on the composition of the flowable component 110. In any event, the result of the solidifying step 116 is the biphasic component 22 with the first primary surface 24 which may be contiguous with the first primary surface 104 of the ceramic 102. The ceramic 102 is now the first ceramic phase 30 of the biphasic component 22. The pores 34 of the ceramic 102 are now the pores 34 through the first ceramic phase 30 of the biphasic component 22. The flowable component 110 that entered the pores 34 of the ceramic 102 have been solidified into the second solid phase 32 of the biphasic component 22.

In embodiments, the solidifying step 116 includes exposing the flowable component 110 to a wavelength or wavelength range of electromagnetic radiation that cures the flowable component 110. In some instances, the flowable component 110 is curable with exposure to ultraviolet radiation. In some instances, the flowable component 110 is curable with exposure to visible light. Other wavelengths of electromagnetic radiation are envisioned, and the appropriate wavelength depends on the curing system (e.g., a curing agent) of the flowable component 110. In such embodiments, the flowable component 110 includes a curing agent that initiates curing of the flowable component 110 upon exposure to the appropriate wavelength of electromagnetic radiation.

In embodiments, the solidifying step 116 includes subjecting the flowable component 110 to a temperature that cures the flowable component 110. In other words, in embodiments, the flowable component 110 is thermally curable. In such embodiments, the flowable component 110 includes a curing agent that initiates curing of the flowable component 110 upon exposure to the appropriate temperature.

In embodiments, the flowable component 110 is or includes a thermosetting resin. For example, the thermoset resin can be one or more of an epoxy resin, an amine-epoxide resin, a phenolic resin, an isocyanate resin, a phenolic resin, a polyimide resin, a silicone resin, a polyurea resin, a (meth)acrylate resin, and a polyurethane resin. As mentioned, the (meth)acrylate resin can be one or more of a urethane-(meth)acrylate and an epoxy-(meth)acrylate, with one or more reactive diluents. Other thermoset resins are envisioned, and these lists are not meant to be exclusive. The thermoset resins may be particularly useful for the solidifying step 116 that includes thermal or electromagnetic radiation curing to solidify the flowable component 110.

In embodiments, the flowable component 110 is or includes neat monomers.

In embodiments, the flowable component 110 includes a mixture of monomers of differing degrees of acrylate functionality. For example, the flowable component 110 can include (i) a difunctional acrylate monomer and (ii) a trifunctional acrylate monomer.

In embodiments, the flowable component 110 includes a curing agent. The curing agent can facilitate polymerization, cross-linking, or both polymerization and cross-linking. There are a wide variety of suitable curing agents available. Suitable examples include photoinitiators and thermal initiator curing agents. Example photoinitiators include (2,4,6-trimethylbenzoyl)-phosphine oxide (TPO), bis(2,4,6-trimethylbenzoyl)-phenylphosphineoxide, 2-hydroxy-2-methyl-1-phenyl-1-propanone. Example thermal initiator curing agents include di-tert-butyl peroxide (DTBP), 2,2′-azobis(2-methylpropionitrile) (AIBN), and diethylenetriamine (DETA). In some embodiments, such as when the flowable component 110 includes an amine-epoxide resin, there is no need for a photoinitiator or a thermal initiator curing agent.

Further, the flowable component 110 can further include one or more of an adhesion promotor and an antioxidant. Suitable adhesion promotors include silanes, zirconates, and titanates, among others. Example silanes include 3-aminopropyltriethoxysilane, glycidoxypropyltrimethoxysilane, vinyltrimethoxysilane, methyltriethoxysilane, and isocyanatopropyltriethoxysilane. Example zirconates include zirconium (IV) n-propoxide, zirconium (IV) 2-methacryloxyethyl acetoacetate, zirconium (IV) acetylacetonate, and zirconium (IV) tert-butoxide. Example titanates include tetra-n-butyl titanate, isopropyl triisostearoyl titanate, and diisopropoxy bis(ethylacetoacetato)titanate.

Suitable antioxidants include hindered phenols, phosphites, and thioesters, among others. Example hindered phenols include tetrakis[methylene(3,5-di-tert-butyl-4-hydroxyhydrocinnamate)]methane, octadecyl 3,5-di-tert-butyl-4-hydroxyhydrocinnamate, and tris[3,5-bis(1,1-dimethylethyl)-4-hydroxybenzyl]isocyanurate. Example phosphites include tris(nonylphenyl) phosphite, triphenyl phosphite, and tris(2,4-di-tert-butylphenyl) phosphite. Example thioesters include dilauryl thiodipropionate and distearyl thiodipropionate. These lists are not meant to be exclusive.

In embodiments, the flowable component 110 is a solid at room temperature but is a liquid at an elevated temperature (relative to room temperature). In such embodiments, the contacting step 112 occurs while the flowable component 110 is liquid at the elevated temperature. Thus, the flowable component 110 can enter the pores 34. After the flowable component 110 enters the pores 34, the solidifying step 116 is performed and includes returning the flowable component 110 to room temperature at which the flowable component 110 is solid. In embodiments, the flowable component 110 includes a thermoplastic polymer, and the temperature manipulation can be useful in those embodiments.

In embodiments, the flowable component 110 is substantially free of a solvent. That means that no solvent has been purposefully added to the flowable component 110 but may be present as a trace component. For example, solvent free resins can be more beneficial to the environment, reduce the cost of the flowable component 110, improve the strength of the second solid phase 32 after solidification of the flowable component 110, and quicken solidification time.

In embodiments, the flowable component 110 includes an alkali metal salt. For example, the flowable component 110 can be a mixture of a thermosetting resin and a lithium salt. Any of the alkali metal salts discussed above are suitable. For example, the flowable component 110 can include one or more of poly(ethylene glycol) methacrylate, polyethylene glycol diacrylate, methacrylated polytetrahydrofuran, poly(ethylene glycol) dimethyl ether, poly(ethylene glycol) methyl ether acrylate, and trimethylolpropane propoxylate triacrylate with a lithium salt such as lithium bis(trifluoromethanesulfonyl)imide or lithium bis(fluorosulfonyl)imide.

In embodiments, the method 100 further includes a removal step 118. The removal step 118 includes removing a portion of the second solid phase 32 at the first primary surface 24 of the biphasic component 22. The portion of the second solid phase 32 is removed while the first ceramic phase 30 remains, or at least more of the second solid phase 32 is removed than the first ceramic phase 30. The removed portion of the second solid phase 32 becomes the cathode portion 40 described above when the biphasic component 22 becomes a component of the rechargeable battery 10.

To remove a portion of the second solid phase 32 but not the first ceramic phase 30, the biphasic component 22 can be contacted with an etchant 120 (see FIG. 7). For example, the biphasic component 22 can be suspended in, or disposed with the first primary surface 24 submerged, into the etchant 120. Suitable etchants 120 will depend on the composition of the second solid phase 32. If the second solid phase 32 includes epoxy resin, then the etchants 120 could include hot concentrated sulfuric acid, chromic acid, or piranha etch. Other etchants 20 will be more suitable for other compositions of the second solid phase 32.

The method 100 further includes a disposing step 122. The disposing step 122 includes disposing the biphasic component 22 between the anode current collector 12 and the cathode 20, with the first primary surface 24 of the biphasic component 22 facing the cathode 20.

### Examples

Example 1—For Example 1, a ceramic having a composition of lithium garnet was prepared. The ceramic was porous.

A flowable composition was then prepared. To prepare the flowable composition, several neat monomers and an UV photoinitiator curing agent were combined and mixed together. More specifically, the flowable composition included 10 wt % M3150, 20 wt % PE210, 58.5 wt % M240, −10 wt % M220, and 1.5 wt % TPO. The monomer M3150 is a trifunctional acrylate monomer, more specifically trimethylolpropane(ethylene oxide)15 triacrylate (available from Miwon Specialty Chemical, Korea). The monomer PE210 is a bifunctional acrylate monomer, more specifically bisphenol-A epoxy diacrylate (available from Miwon Specialty Chemical, Korea). The monomer M240 is an ethoxylated (4) bisphenol-A diacrylate (available from Miwon Specialty Chemical, Korea). The monomer M220 is neopentylglycol(propylene oxide)2 diacrylate (available from Miwon Specialty Chemical, Korea). The photoinitiator curing agent TPO is (2,4,6-trimethylbenzoyl)-phosphine oxide (available from BASF, Germany).

The liquid viscosity of the flowable composition at 25° C. was measured to be 11.0 poise. To measure the liquid viscosity, a Brookfield CAP2000 viscometer was used. The plate of the viscometer was heated to 25° C. A few (3-4) drops of the flowable composition were placed on the plate and a spindle #4 was used to measure the viscosity at a speed of 100 rpm.

The flowable composition was then cast onto a liner of PET. More specifically, a drawdown bar applicator was used to cast a 126 μm thick layer of the flowable composition onto the PET liner. A first primary surface of the ceramic was then set into the layer of the flowable composition on the PET liner. The ceramic was allowed to set within the flowable composition for 15 seconds to allow for the flowable composition to enter the pores of the ceramic.

Ultraviolet radiation at 254 nm having an energy density of 2.4 J/cm² was then directed through the liner and onto the flowable composition. The ultraviolet radiation caused the flowable composition to cure into a second solid phase thus forming a biphasic component with the second solid phase disposed within the pores of the first ceramic phase. The liner was then removed from the biphasic component.

The Young's modulus and elongation on break of the second solid phase were measured to be 2.08 GPa and 31.7%, respectively. The Young's modulus and elongation on break were determined using an Instron 2G load cell frame, according to the process described above using 5 inch long rods of the cured flowable composition representing second solid phase.

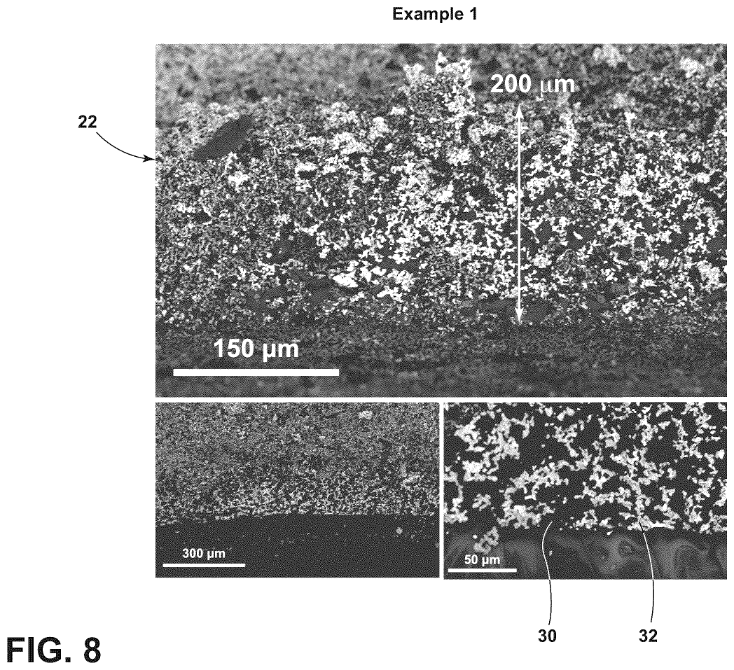

The biphasic component was then cross-sectioned. Several images of the cross-section of the biphasic component were captured using scanning electron microscopy (SEM). The images are reproduced at FIG. 8. The images show the second solid phase disposed within the pores of the first ceramic phase.

Example 2—For Example 2, another flowable composition was made, this time an amine-epoxide resin. The flowable composition included 25 wt % Amicure PACM and 75 wt % 1,4-cyclohexanedimethanol diglycidyl ether. Amicure PACM is 4,4′-methylenebis(cyclohexanamine) (available from Evonik Corp., USA). The flowable composition was allowed to enter the pores of a ceramic. The flowable component within the pores was then solidified via thermal curing by subjecting the ceramic with the flowable component to an argon environment having a temperature within a range of 100° C. to 150° C. for two hours. A biphasic component resulted.

Example 3—For Example 3, another flowable composition was made, this time with a UV curable monomer and a lithium salt. More specifically, the flowable composition included 74 wt % polyethylene glycol diacrylate, 25 wt % lithium bis(trifluoromethanesulfonyl) imide, and 1 wt % 2-hydroxy-2-methyl-1-phenyl-1-propanone (as a UV curing initiator). The components of the composition were continuously stirred for 24 hours. A ceramic was then contacted with the flowable composition with the flowable composition entering the pores of the ceramic. The flowable composition within the pores was subjected to ultraviolet radiation for 1 hour to cure the flowable composition. The cured flowable composition was a thermoset polymer with the lithium salt. The resulting article was a biphasic component with a first ceramic phase with pores and a second solid phase of the thermoset polymer within the pores.

What is claimed is:

1. A rechargeable battery comprising:
an anode current collector;
a cathode current collector separated from the anode current collector by a battery distance, the anode current collector and the cathode current collector at least partially defining a battery space;
a cathode disposed within the battery space in electrical communication with the cathode current collector, the cathode capable of storing alkali ions; and
a biphasic component disposed within the battery space between the anode current collector and the cathode, the biphasic component comprising
(a) a first ceramic phase,
(b) pores throughout the first ceramic phase, and
(c) a second solid phase disposed within the pores of the first ceramic phase throughout (i) a separator portion of the biphasic component but not throughout (ii) an anode portion of the biphasic component, the separator portion being disposed between the anode portion and the cathode and forming a physical barrier between the pores through the first ceramic phase at the anode portion and the cathode,
wherein, the first ceramic phase provides a continuous conduction path for the alkali ions through the separator portion to the anode portion;
wherein, the biphasic component at the separator portion exhibits (i) an electronic conductivity of less than 10⁻⁶ S/cm and (ii) an ionic conductivity of greater than 10⁻⁵ S/cm; and
wherein, during a charging process of the rechargeable battery, the alkali ions from the cathode are reduced to atoms of alkali metal that collect as alkali metal within the pores of the first ceramic phase at the anode portion of the biphasic component.

2. The rechargeable battery of claim 1 further comprising:
a liquid electrolyte disposed within pores of the cathode,
wherein, the second solid phase is substantially impermeable to the liquid electrolyte, and
wherein, the liquid electrolyte is conductive of the alkali ions.

3. The rechargeable battery of claim 2, wherein
the liquid electrolyte comprises an alkali metal salt dissociated within a solvent.

4. The rechargeable battery of claim 1, wherein
the second solid phase is not disposed throughout a cathode portion of the biphasic component, and
the cathode portion is disposed between the second solid phase and the cathode.

5. The rechargeable battery of claim 4, wherein
the cathode portion of the biphasic component comprises a length parallel to the battery distance that is within a range of from greater than 0 μm to 5 μm.

6. The rechargeable battery of claim 1, wherein:
(i) the first ceramic phase has been sintered; or
(ii) (ii) the first ceramic phase comprises a lithium garnet ceramic; or
(iii) (iii) the first ceramic phase comprises lithium lanthanum zirconium oxide (LLZO) or LLZO doped with a dopant.

7. The rechargeable battery of claim 1, wherein:
(I) the first ceramic phase comprises lithium lanthanum zirconium oxide (LLZO) or LLZO doped with a dopant; and the dopant comprises one or more of Al, Nb, Ta, Ga, Be, Nd, Gd, Y, Ca, Sr, W, Hf, Ti, Si, In, Bi, Sb, Mg, Sc, Dy, Yb, Ce, and Fe; or
(II) (ii) the first ceramic phase comprises one or more of Li_{6.25}Al_{0.25}La₃Zr₂O₁₂, Li_{6.75}La₃Zr_{1.75}Nb_{0.25}O₁₂, Li_{6.5}La₃Zr_{1.5}Ta_{0.5}O₁₂, and Li_{6.75}La₃Zr_{1.75}Ta_{0.25}O₁₂; or
(III) the first ceramic phase comprises one or more of the following substitutions:
(i) Li₇₋₃ₐLa₃Zr₂MₐO₁₂, where M=Al, Ga, or Be, and 0<a<0.33;
(ii) Li₇La_{3-b}Zr₂M_{b}O₁₂, where M=Nd, Gd, or Y, and 0<b<1;
(iii) Li_{7-c}La₃Zr_{2-c}M_{c}O₁₂, with M=Nb or Ta, and 0<c<1;
Li₇₊ₐLa_{3-d}Zr₂MO₁₂, where M=Ca or Sr, and 0<d<1;
Li₇₊₂ₑLa₃Zr₂₋ₑMₑO₁₂, where M=Ca and 0<e<0.25; and
(Li_{7-2f}La₃Zr₂₋ᵣM_{f}O₁₂, where M=W and 0<f<0.5.

8. The rechargeable battery of claim 1, wherein
the second solid phase comprises a polymer.

9. The rechargeable battery of claim 8, wherein
the polymer comprises a thermoplastic polymer.

10. The rechargeable battery of claim 9, wherein
the thermoplastic polymer comprises one or more of polypropylene, polyethylene, or polystyrene.

11. The rechargeable battery of claim 8, wherein
the polymer comprises a thermoset polymer.

12. The rechargeable battery of claim 11, wherein
the thermoset polymer comprises vulcanized rubber.

13. The rechargeable battery of claim 11, wherein
the thermoset polymer comprises a thermoset resin.

14. The rechargeable battery of claim 13, wherein
the thermoset resin comprises one or more of an epoxy resin, an amine-epoxide resin,
a phenolic resin, an isocyanate resin, a phenolic resin, a polyimide resin, a silicone resin,
a (meth)acrylate resin, a polyurethane resin, and a polyurea resin.

15. The rechargeable battery of claim 14 wherein
the (meth)acrylate resin comprises one or more of a urethane-(meth)acrylate and an epoxy-(meth)acrylate, with one or more reactive diluents.

16. The rechargeable battery of claim 8, wherein
the polymer is derived from polymerization of one or more of poly(ethylene glycol) methacrylate, polyethylene glycol diacrylate, methacrylated polytetrahydrofuran, poly(ethylene glycol) dimethyl ether acrylate, poly(ethylene glycol) methyl ether acrylate, and trimethylolpropane propoxylate triacrylate.

17. The rechargeable battery of claim 8, wherein
the polymer exhibits an ionic conductivity within a range of from 10-7 S/cm to 10-4 S/cm.

18. The rechargeable battery of claim 1, wherein
the second solid phase exhibits an ionic conductivity that is greater than 10⁻⁷ S/cm.

19. The rechargeable battery of claim 1, wherein
the second solid phase comprises an alkali metal salt.

20. The rechargeable battery of claim 19, wherein
the alkali metal salt comprises one or more of lithium bis(trifluoromethanesulfonyl)imide and lithium bis(fluorosulfonyl)imide.

21. The rechargeable battery of claim 19, wherein
the alkali metal salt comprises one or more salts of the formula J₃MX₆, where J is an alkali metal, M is a trivalent rare earth metal, and X is F, Cl, Br, or I.

22. The rechargeable battery of claim 1, wherein:
(I) the second solid phase exhibits a Young's modulus of greater than or equal to 0.5 MPa at 25° C.

23. The rechargeable battery of claim 1, wherein
the second solid phase exhibits a Young's modulus of greater than or equal to 1 GPa at 25° C.

24. The rechargeable battery of claim 1, wherein:
(I) the alkali metal is lithium, and the alkali ions are lithium ions; or
(II) the alkali metal is sodium, and the alkali ions are sodium ions.

25. The rechargeable battery of claim 1, wherein:
(I) the anode portion of the biphasic component comprises a length parallel to the battery distance that is within a range of from 5 μm to 150 μm; or
(II) the separator portion of the biphasic component comprises a length parallel to the battery distance that is within a range of from 1 μm to 50 μm

26. A method of manufacturing a rechargeable battery comprising:
with a ceramic comprising (i) pores throughout the ceramic, (ii) a first primary surface, (iii) a second primary surface, and (iv) a length between the first primary surface and the second primary surface, a contacting step comprising contacting the first primary surface of the ceramic with a flowable component so that the flowable component enters the pores of the ceramic and resides within the pores through less than an entirety of the length of the ceramic;
a solidifying step comprising solidifying the flowable component residing within the pores of the ceramic, thus resulting in a biphasic component comprising (i) a first primary surface contiguous with the first primary surface of the ceramic, the ceramic representing a first ceramic phase, (ii) pores throughout the first ceramic phase, and (iii) a second solid phase derived from solidifying the flowable component disposed within the pores; and
a disposing step comprising disposing the biphasic component between an anode current collector and a cathode, with the first primary surface of the biphasic component disposed facing the cathode.

27. The method of claim 26, wherein:
(I) the ceramic is a lithium garnet ceramic; or
(II) the contacting step comprises (i) casting the flowable component onto a liner at least partially transparent to ultraviolet radiation and (ii) placing the first primary surface of the ceramic into the flowable component that was casted; or
(III) the contacting step comprises coating the flowable component onto the first primary surface of the ceramic; or
(IV) the contacting step comprises coating the flowable component onto the first primary surface of the ceramic; or
(V) the solidifying step comprises exposing the flowable component to a wavelength or wavelength range of electromagnetic radiation that cures the flowable component; or
(VI) the solidifying step comprises subjecting the flowable component to a temperature that cures the flowable component; or
(VII) the flowable component comprises a thermosetting resin.

28. The method of claim 26, wherein:
(I) the flowable component comprises a thermosetting resin; and
the thermoset resin comprises one or more of an epoxy resin, an amine-epoxide resin, a phenolic resin, an isocyanate resin, a phenolic resin, a polyimide resin, a silicone resin, a (meth)acrylate resin, a polyurethane resin, and a polyurea resin; or
(II) the (meth)acrylate resin comprises one or more of a urethane-(meth)acrylate and an epoxy-(meth)acrylate, with one or more reactive diluents; or
(III) the flowable component comprises neat monomers; or
(IV) the flowable component comprises (i) a difunctional acrylate monomer, and (ii) a trifunctional acrylate monomer; or
(V) the flowable component comprises a curing agent.

29. The method of claim 26, wherein:
(I) the flowable component is a solid at room temperature but a liquid at an elevated temperature, the contacting step occurs while the flowable component is the liquid at the elevated temperature, and the solidifying step comprises returning the flowable component to room temperature; or
(II) the flowable component comprises a thermoplastic polymer; or
(III) the flowable component is substantially free of a solvent; or
(IV) the flowable component comprises an alkali metal salt; or
(V) the flowable component comprises an alkali metal salt; or
(VI) a removal step comprising removing a portion of the second solid phase at the first primary surface of the biphasic component.
